(19) United States
(12) Patent Application Publication
(10) Pub. No.: US 2004/0227098 A1
(43) Pub. Date: Nov. 18, 2004

(54) Position sensitive neutron detector

(76) Inventor: Iouri Tarabrine, Mississauge (CA)

Correspondence Address: Iouri Tarabrine, 915 Binscarth Drive, Mississauga, ON, L5V 1N1, CA

(21) Appl. No.: 10/837,690

(22) Filed: May 4, 2004

Related U.S. Application Data
(60) Provisional application No. 60/469,890, filed on May 13, 2003.

(51) Int. Cl. G01T 3/06

(52) U.S. Cl. 250/390.11

(57) ABSTRACT

The invention provides an improved neutron detector of fast neutrons and may be used particularly in the advanced detection technologies for the non-intrusive interrogation of passengers luggage, large cargo and trucks.

The proposed detector of fast neutrons consists of fiber block (parallelepiped), which is assembled of the layers of polymer scintillating fibers, oriented in two mutually perpendicular directions and optoelectronic system of registration of optical irradiation.

Optoelectronic system of registration is based upon position sensitive photo-receivers, which are optically coupled with corresponding of fiber edges. Optoelectronic system consists of two local optical sub-systems. The first (main) sub-system matches each individual fiber edge with corresponding element of two-dimensional position sensitive photo-receiver. The second (complementary) sub-system matches columns and rows of fiber edges with corresponding individual pixels of fast linear photo-receivers.

### CROSS REFERENCE TO RELATED APPLICATIONS

The Applicant claims the priority benefit of earlier filed U.S. Provisional Application No. 60/469890 of May 13^{th}, 2003

### BACKGROUND OF THE INVENTION

The invention pertains to fast neutron detectors and can be used, particularly, for the detection of hidden chemical explosives and other smuggled items.

It is known that the vast majority of smuggled substances, which comprise the interest for non-intrusive analysis and inspection, including organic substances, are characterized by the presence of hydrogen, nitrogen, oxygen, carbon and a few other light (M<30) chemical elements in their content. Chemical composition of such a substances is characterized by certain ratio between the quantities of light chemical elements nuclei. The presence of some of these elements, particularly nitrogen, is used for the detection of explosives, particularly in the hand luggage of passengers, to provide a secure transportation. Difference in the nuclear features of light chemical elements allows the application of different nuclear technologies (particularly, elastic and inelastic scattering of fast neutrons on different nuclei) for detection of organic substances and their imaging inside different enclosures, without their opening.

A typical detection system consists two main components:

source of detecting irradiation, particularly neutron source;

a set (array) of detectors for the registration of scattered in different ways particles (irradiation) of primary source.

One of the most important units of the detection system, which is based upon interrogation by fast neutrons, comprises a detector of fast neutrons. It has to be used in the systems, which are based on the elastic scattering, as well in the combined (elastic-inelastic principle) systems, for the detection of hydrogen.

A mandatory intrinsic feature of such a detector is position sensitivity. This feature is important both for the detection of space distribution of hidden material and for the detection of its chemical content.

The present invention improves a performance of fiber-optic position sensitive detector of fast neutrons through the use of combined system of optical irradiation registration, which combines the benefits of standard two-dimensional optical receiver of high space resolution and fast one-dimensional photo-receiver.

The proposed detector of fast neutrons consists of fiber block, which is assembled of layers of polymer scintillating fibers, oriented in two mutually perpendicular directions and optoelectronic system for registration of optical irradiation.

Optoelectronic registration system is based upon position sensitive photo-receivers, which are optically coupled with corresponding edges of fiber parallelepiped. Optoelectronic system consists of two local optical subsystems. The first (main) subsystem matches each individual fiber edge with corresponding element of two-dimensional position sensitive photo-receivers of high space resolution. The second (complementary) subsystem matches columns of fiber edges with corresponding individual pixels of fast linear photo-receiver.

Position Sensitive Neutron detectors are shown, for example, in the following patents:

| | |
|---|---|
| U.S. Pat. No. 4,942,302 | Koechner |
| RF 2,119,178 | Tarabrin |
| U.S. Pat. No. 4,454,424 | Strauss, Brenner |
| U.S. Pat. No. 5,298,756 | McCollum, Spector |

### BRIEF SUMMARY OF THE INVENTION

Considered broadly, detectors according to the invention are of the scintillating type and comprise a combination of scintillating block and system for the registration of optical irradiation generated inside a scintillating block.

Some of applications of similar detectors require position sensitivity as a feature, which is mandatory for the normal performance of the unit. The particular group of these applications comprises non-intrusive inspections and interrogations.

The proposed detector of fast neutrons consists of fiber block, which is assembled from the layers of polymer scintillating fibers, oriented in two mutually perpendicular directions and optoelectronic system of registration of optical irradiation.

Optoelectronic system of registration is based upon position sensitive photo-receivers, which are optically coupled with corresponding fiber edges. Optoelectronic system consists of two local optical sub-systems. The first (main) sub-system matches each individual fiber edge with corresponding element of two-dimensional position sensitive photo-receiver. The second (complementary) sub-system matches columns and rows of fiber edges with corresponding individual pixels of fast linear photo-receivers.

### IN THE DRAWINGS, WHICH FORM A PART OF THIS SPECIFICATION,

FIG. 1 is 3-D general arrangement view of the detector;

FIG. 2 is Cross Section of the complementary local optical sub-system in more details;

FIG. 3 is Cross Section of the main local optical sub-system in more details

### DETAILED DESCRIPTION

In the particularly advantageous embodiment of the invention illustrated, fiber optic block 1 is assembled of fiber layers stacked alternately in two mutually perpendicular directions and the length of layers of fiber optic block in each direction is equal to the dimension of the corresponding edge of fiber block. Furthermore, fiber edges are placed in the planes of the edges of fiber optic parallelepiped, formed by the fiber layers. Furthermore, to provide the registration of neutron at least by two adjacent layers of fiber optic block, the diameter of single fiber is chosen by the ratio D˜1/2 where 1—mean free path of recoil proton in fiber material.

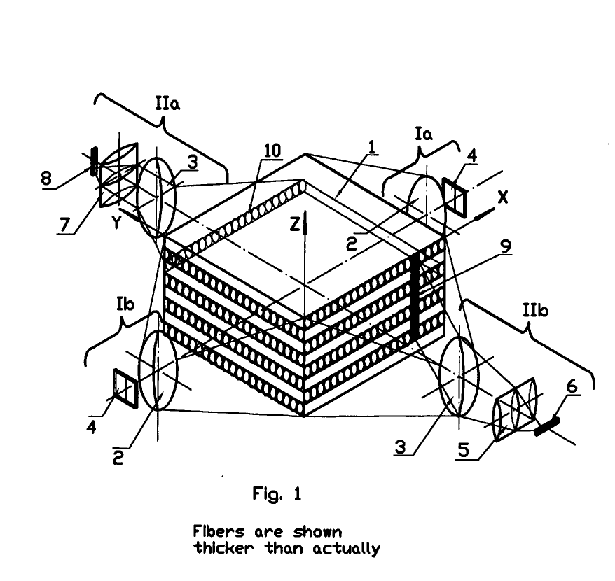

Advantageously, optoelectronic system of registration of optical irradiation, coming out of the edges of scintillating optical fibers, is based upon position sensitive photo-receivers 4, 6 and 8 in FIG. 1, which are optically coupled with corresponding edges of fiber parallelepiped. Optoelectronic system consists of two local optical subsystems I and II working in “X” and “Y” directions, correspondingly. Therefore, the first (main) subsystem I consists of two projection modules I a and I b. Lenses 2 match each individual fiber edge with corresponding element of two-dimensional position sensitive photo-receivers 4. The second (complementary) subsystem II consists of two projection modules II a and II b. Moreover, each module has spherical 3 and cylindrical 5 and 7 components. Cylindrical lens 5 and linear fast position sensitive photo-receiver 6 of module II b are oriented so that each column of fiber edges 9 is projected onto corresponding pixel of photo-receiver.

Cylindrical lens 7 and linear fast position sensitive photo-receiver 8 of module II a are oriented so that each row of fiber edges 10 is projected onto corresponding pixel of photo-receiver 8.

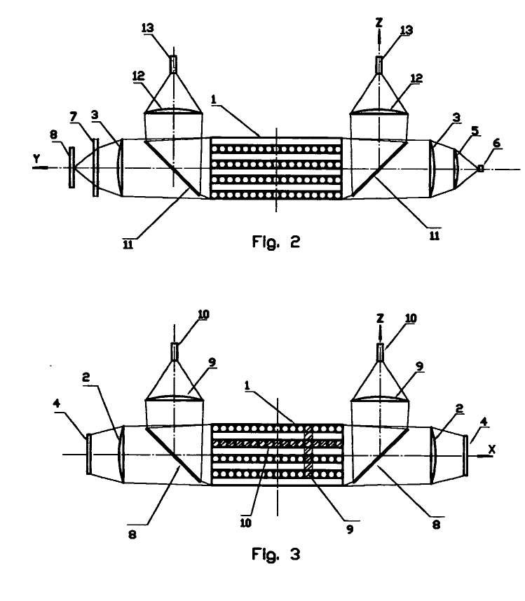

Referring to FIG. 2 and 3, for the realization of possibility of precise registration of time of the first interaction of neutron with the detector material, the local optical subsystems include semi-transparent plates 11 (not shown in FIG. 1), redirecting a portion of optical power to the auxiliary fast photo-receivers 13 through the objective lens 12.

For the improvement of detector performance realized in the increase of its loading capability with respect to neutron flux, optoelectronic registration system is based upon position sensitive photo-receivers, which are optically coupled with corresponding edges of fiber parallelepiped. Optoelectronic system consists of two local optical sub-systems. The first (main) subsystem I matches each individual fiber edge with corresponding element of two two-dimensional position sensitive photo-receivers 4. The second (complementary) sub-system matches columns of fiber edges 9 with corresponding individual pixels of fast linear photo-receiver 6 (module II b) and rows of fiber edges 10 with corresponding individual pixels of fast linear photo-receiver 8 (module II a). Furthermore, in the main sub-system the working cycles of two position sensitive photo-receivers 4 are organized so to collect the optical information and discharge it into data acquisition system in series: while one photo receiver is collecting optical information, the other is transferring the previously collected information to data acquisition system.

The suggested device can be used in the industry, particularly, in neutron tomographs for geological logging, for the detection of hidden explosives, warfare and drugs, for medical inspections of internal biological tissues of human without surgery, therefore it is applicable in industry.

### EXAMPLE 1

One of the most important characteristics of detector, which defines its practical usefulness, is the energetic efficiency of the detector.

Below is presented an estimate of photon flux to the single element of position sensitive photo receiver. This value can be calculated by formula

N=(Eₚ/Eₚₕ)ηₗᵤₘ(Ω_{NA}/8π)(1/<K_{abs}>)KₒₚₜΓₛₚ (1)

where Eₚ—the energy of recoil proton, generated in the particular fiber of detector block;

Eₚₕ—photon energy;

ηₗᵤₘ—energy efficiency of luminescence;

Ω_{NA}—solid angle defined by the numerical aperture of scintillating fiber;

<K_{abs}>—averaged coefficient of fibers optical absorption;

Kₒₚₜ—transmission coefficient for the optical channel;

Γₚ—partition coefficient of semitransparent plate;

<K_{abs}>=10^{((Lf/2)k[dB/m]/10)};

k[dB/m]—coefficient of optical absorption of fibers in the spectral region of luminescence;

Lf—dimension of fiber block in the direction of fibers length;

Kₒₚₜ=(1−ε_{fr})^{nos}—in the case of full matching of apertures of optical system components;

nos—number of optical surfaces along the trajectory of optical ray in the optical system of the detector;

ε_{fr}—Fresnel's coefficient of reflection for the normal incidence of optical ray;

The total thickness of stack of optical fibers is chosen form the ratio

H˜L (2),

where L—free path of registered neutron in fiber material.

Diameter of single fiber is chosen for the ratio

D˜1/2 (3),

where 1—free path of recoil proton in fiber material.

The proposed device works in the following way.

Fast neutron passes through fiber block of the detector 1 and generates a recoil proton in one of the polymer fibers. As proton is charged particle, it causes the ionizing generation of photons in the fiber material. As the condition (3) is valid, the photons are generated at least in two adjacent layers of fibers. Generation of the second recoil proton is very unlikely due to the condition (2). Photons propagating within a numerical aperture of fiber become canalized to both output edges of the fiber.

Local optical subsystem I projects each fiber onto corresponding element of position sensitive photo receivers 4. In such a way two co-ordinates (“Y” and “Z”) of the elastic interaction of neutron with the detector material are registered. The third co-ordinate (“X”) is registered by the complementary optical subsystem II. To realize high loading capability of the detector with respect to neutron flux, in the complementary local subsystem II the position sensitive photo receivers 6 and 8, comprise linear device (one-dimensional position sensitivity). Module II a of the subsystem II provides the unique identification of registered by subsystem I pairs (X, Y) as “Z” co-ordinate registered by photo-receiver 8 is the same as registered by photo-receiver 4 (within a small inaccuracy due to finite thickness of individual fiber). Module II b of the subsystem II provides the registration of “X” co-ordinate of interaction point of neutron with fiber optic block.

Precise registration of time of the first interaction of registered neutron with the fiber block material is provided by the additional optical components (semi-transparent plates 11, objective lenses 12 and fast photo-receivers 13).

### EXAMPLE 2

Fiber optic block is assembled of polymer fibers polysterene-PMMA. The diameter of single fiber is chosen from the ratio

D˜1/2 (3),

Where 1—the length of mean free path of recoil proton: ˜2 mm for E=14 MeV; diameter of fibers from a commercially available row—0,4 mm;

Chemical composition of fibers:

polysterene: n*(C₈H₉);

PMMA: n*(C₅H₆O₂);

Refraction Indexes: n=1,49 . . . 1,59(core); n=1,406 . . . 1,49(cladding);

Numerical Aperture: N.A.=(n₁²−n₂²)⁰⁵; N.A.=0,45 . . . 0,72

Optical Absorption: 0,2 . . . 2,0 dB/m in the range of luminescence wavelengths;

Time uncertainty arising from the difference of travelling of different wave modes form the point of neutron interaction with fiber material to the edge of the fiber (jitter) can be estimated in the following way:

For multi mode fibers (2π(N.A.)/λ>2.4), where N.A.—numerical aperture of fiber, λ—wavelength, this value can be expressed as

dt/L=n₁/c(n₁²−n₂²)/2n₁² (4)

where n₁ [symbol] n₂—refraction indexes of core and cladding, correspondingly

For (n₁−n₂)˜0.1 dt/L˜0.1 ns/m;

CCD matrixes with a photo-layer quantum efficiency close to 100% in the region of fiber luminescence can be used as the position sensitive photo-receivers 4. Light ray passing through the main local optical subsystem meets five boundaries glass-air.

Necessary thickness of fiber block is chosen from the ratio:

H˜L (2),

where L—free path of the registered neutron in the fiber material (˜15 cm to achieve 90% of registration efficiency of 14-M [symbol] B neutrons);

Width of the edges of fiber block: 300 mm and 500 mm;

Energy efficiency of transformation: 2.4%;

Spectral region of luminescence: 400 . . . 500 _{HM};

Fluorescence decay time (the duration of the scintillation pulse): (1 . . . 3) 10⁻⁹s;

Energy Resolution: from 4 to 8% for the bundle of 10×10 fibers.

Auxiliary fast photo-receiver 10: photo-multiplier with leading edge of output pulse ˜0,5 ns;

Semi-transparent plate 8 with partition coefficient 0.5.

According to the presented values and formula (1), we'll get

N=123 photon/MeV, which is sufficiently enough for the registration by modern position sensitive photo receivers.

### EXAMPLE 3

Estimate of loading capability of the detector.

readout time for the two-dimensional CCD photo-receiver: 50 ms;

the worst readout time for linear CCD photo-receiver: 64 μs;

possible time interval between of two registration events: 64 μs;

factor for the loading capability improvement for the proposed detector: (50/64)*103=780

Comparison of the proposed device with existing shows, that the first allows to detect fast neutrons of 1-14 MeV energy with high efficiency, and remarkably improve the loading capability of detector.

1. In a position sensitive neutron detector, comprising the combination of fiber optic block and optoelectronic system for registration of optical irradiation, coming out of the edges of scintillating optical fibers:
fiber optic block is assembled of fiber layers stacked alternately in two mutually perpendicular directions; fiber edges are placed in the planes of the edges of fiber optic parallelepiped, formed by the fiber layers;
the length of layers of fiber optic block in each direction is equal to the dimension of the corresponding edge of fiber block;
diameter of single fiber is chosen by the ratio D˜1/2 where 1—mean free path of recoil proton in fiber material;
optoelectronic system of registration is based upon position sensitive photo-receivers, optically coupled with corresponding edges of parallelepiped;
optoelectronic system of registration incorporates semi-transparent plates, redirecting a portion of optical power to the auxiliary fast photo-receivers;

2. The combination defined in claim 1, wherein said optoelectronic system of the position sensitive neutron detector consists of two local optical sub-systems, optically coupling mutually perpendicular edges of parallelepiped to the position sensitive photo-receivers; the first (main) sub-system matches each individual fiber edge to the corresponding group of pixels of two-dimensional position sensitive photo-receiver; the second (complementary) sub-system matches rows and columns of fiber edges to the corresponding pixels of one dimensional (linear) position sensitive photo-receiver;

3. The position sensitive neutron detector recited in claim 1, wherein said position sensitive photo-receiver of the main local optical sub-system comprising two-dimensional photo-receivers of high space resolution;

4. The position sensitive neutron detector recited in claim 1, wherein said position sensitive photo-receivers of the complementary local optical sub-system comprising one-dimensional (linear) fast photo-receivers;

5. The position sensitive neutron detector defined in claim 2, wherein said the complementary local optical sub-system inclusive of cylindrical optical components;

6. The position sensitive neutron detector defined in claims 2, wherein said the main local optical sub-system inclusive of two two-dimensional photo-receivers of high space resolution, collecting the optical information from the different sides of the fiber optic block;

7. The position sensitive neutron detector defined in claim 6 wherein said working cycles of two two-dimensional photo-receivers of high space resolution are organized so to collect the optical information and discharge it into data acquisition system in series: while one photo receiver is collecting optical information, the other is transferring the previously collected information to data acquisition system;

8. The position sensitive neutron detector defined in claim 4 wherein said the first of two fast linear photo-receivers provides the unique identification of the point of interaction of fast neutron with fiber block material;

9. The combination defined in claim 4 wherein said the second of two fast linear photo-receivers provides the registration of the third co-ordinate of the point of interaction of fast neutron with fiber block material
